(19) United States
(12) Patent Application Publication
(10) Pub. No.: US 2014/0259818 A1
(43) Pub. Date: Sep. 18, 2014

(54) TENT CARD AND METHODS OF MAKING AND USING THE SAME

(71) Applicant: AVERY DENNISON CORPORATION, Pasadena, CA (US)

(72) Inventors: Eric J. Cushing, Los Angeles, CA (US); Jerry G. Hodsdon, Forestdale, MA (US); Brian R. McCarthy, Anaheim Hills, CA (US)

(21) Appl. No.: 13/842,961

(22) Filed: Mar. 15, 2013

(51) Int. Cl. G09F 1/06; G09F 1/10

(52) U.S. Cl. CPC G09F 1/06; G09F 1/10
USPC 40/124.14; 40/124.01; 29/428

(57) ABSTRACT

An apparatus that is configured to stand on a supporting surface and methods of making and using the same. According to one embodiment, the apparatus includes a print-receptive surface and a biasing mechanism. The biasing mechanism is configured to bias the print-receptive surface into a standing configuration relative to the supporting surface.

### FIELD OF THE INVENTION

The present invention relates generally to tent cards and methods of making and using the same.

### BACKGROUND

There are many situations in which it can be desirable to display printed information, e.g., text and/or images, at an angle other than facing directly upwardly from a desk, table, or similar horizontal surface. As one example, in dining establishments, it is often desirable to display certain menu items or other advertising using a standing table display that is viewable by those individuals seated at the table. As another example, in many retail establishments, it is often desirable to display to prospective customers sales-related information using a standing display that can be easily viewed from a distance. As still another example, it is often desirable at large functions for seating assignments to be displayed on a common table using standing place cards.

For situations such as the foregoing, tent cards are commonly used as the medium for receiving and displaying the printed information. Tent cards typically come in a number of different varieties. In one common variety, the tent card is assembled from a sheet of cardstock having a score line that bisects the sheet longitudinally into a pair of panels. In use, information is printed on one or both panels, the sheet is then folded along its score line to assume a V-shape (see FIG. 33), and the folded sheet is then propped up in a standing position on a horizontal surface, with the free edge of each panel in contact with the horizontal surface and with the folded edge separating the two panels spaced above the horizontal surface. In another common type of tent card, the sheet of cardstock has two score lines to permit the sheet to be folded into a triangular structure having three panels, namely, a pair of print-receptive panels and a base panel, the base panel extending from one of the two print-receptive panels and being adapted to lie on top of the horizontal surface (see FIG. 34).

An emerging use for tent cards, particularly of the two-panel variety described above, is in the classroom. According to one such use, the print-receptive panels of the tent card are provided with a conventional dry-erase coating. In use, a student handwrites information on one or both panels using a dry-erase marker, then folds the card into a V-shape, and then stands the card on his desk in the above-described manner for viewing by a teacher or by other students. Thereafter, if the student wishes to erase the information from the panels or wishes to write new information on the panels, the student typically flattens the card on his desk by pressing the folded edge separating the panels downwardly against the desk, then wipes the panels clean and/or handwrites new information on the panels, and then re-folds the card and again stands the card on his desk. As can be appreciated, each time information is erased, from or handwritten onto the panels, the student must repeat the steps of flattening the card on the desk, and thereafter, re-folding and propping the card up in a standing position on the desk. Over time, the repeated propping up of the card can become tedious. Moreover, even when propped up, such cards have a tendency not to stand stably and flatten over time when in a standing position.

It should, therefore, be appreciated that there is a need for a tent card that can stand reliably, yet be repeatedly flattened for writing upon. The present invention satisfies this need.

### SUMMARY

An exemplary embodiment of the invention includes an apparatus that is configured to stand on a supporting surface. The apparatus includes a print-receptive surface and a biasing mechanism. The biasing mechanism is configured to bias the print-receptive surface into a standing configuration relative to the supporting surface.

In other, more detailed features of the invention, the apparatus is a tent card. In other, more detailed features of the invention, the print-receptive surface can be, for example, a dry-erase film, a wet-erase film, a semi-permanent marker erasable film, a polypropylene film (PP), a polymeric film, a paper, laminates thereof, or coatings thereof. In other, more detailed features of the invention, print-receptive surface is configured to accept markings from a writing implement, for example, dry-erase markers, wet-erase markers, semi-permanent markers, permanent markers, chalk, pencils, pens, or crayons. In other, more detailed features of the invention, the biasing mechanism includes a strip of film. In other, more detailed features of the invention, the strip of film is made of a material, and the material can be, for example, polyester (PET), polypropylene (PP), polyethylene (PE), polyolefin, polyamide, reinforced paper, or non-woven fabric.

In additional, more detailed features of the invention, the third portion is joined to itself using a mechanical fastener. In other, more detailed features of the invention, the mechanical fastener is a clip.

In further, more detailed features of the invention, the apparatus includes a first panel, and the print-receptive surface is part of the first panel. In other, more detailed features of the invention, the biasing mechanism is coupled to the first panel. In other, more detailed features of the invention, the apparatus further includes a second panel that is coupled to the first panel.

In yet additional, more detailed features of the invention, the first panel includes a first panel portion, the second panel includes a second panel portion, and the first panel portion is coupled to the second panel portion. In other, more detailed features of the invention, the biasing mechanism includes a first strip of film, and the first strip of film is coupled to the first panel portion.

In other, more detailed features of the invention, the first panel has a first panel surface, and the first strip of film is coupled to the first panel surface. In other, more detailed features of the invention, the second panel has a second panel surface, the biasing mechanism includes a second strip of film, the second strip of film is coupled to the second panel portion, and the second strip of film is coupled to the second panel surface.

In yet additional, more detailed features of the invention, the biasing mechanism include a plurality of strips of film and the plurality of strips of film includes the first strip of film. In additional, more detailed features of the invention, the apparatus has a length, the first strip of film has a length, and the length of the first strip of film is less than the length of the apparatus.

In additional, more detailed features of the invention, the apparatus further includes a bonding mechanism, and the bonding mechanism couples the first panel to the second panel. In other, more detailed features of the invention, the bonding mechanism is selected from the group consisting of an adhesive, a double-sided adhesive tape, a transfer tape, a permanent adhesive, and a pressure-sensitive adhesive. In yet other, more detailed features of the invention, the apparatus further includes a fastener that is configured to contact both the first panel and the second panel. In more detailed features of the invention, the fastener is a clip.

In other, more detailed features of the invention the first panel and the second panel are formed from a single sheet of material. In additional, more detailed features of the invention the sheet of material can be, for example, paper, cardboard, film, a polymeric sheet, a polymer-coated paper, and laminates thereof.

In additional, more detailed features of the invention, the single sheet of material includes a fold, and the fold defines a boundary between the first panel and the second panel. In other, more detailed features of the invention, at least one of the first panel and the second panel is embossed to define a writing area.

An exemplary method according to the invention is a method of manufacturing an apparatus that is configured to stand on a supporting surface. The method includes the step of providing a flat sheet having a print-receptive surface. The method also includes the step of coupling a biasing mechanism to the flat sheet. The biasing mechanism is configured to bias the flat sheet into a standing configuration relative to the support surface.

In more detailed features of the invention, the method includes the step of scoring the flat sheet to form a fold line. The apparatus includes a first panel and a second panel, and the fold line defines the boundary between the first panel and the second panel. In other, more detailed features of the invention, the method includes the step applying a bonding mechanism to the flat sheet. In other, more detailed features of the invention, the method includes the steps of folding the flat sheet along the fold line and coupling the first panel to the second panel with the bonding mechanism. In additional, more detailed features of the invention, the biasing mechanism is a strip of film. In other, more detailed features of the invention, the method includes the step of embossing the flat sheet.

An exemplary method according to the invention is a method of using an apparatus that includes a print-receptive surface and that is configured to stand on a supporting surface. The method includes the step of applying a first flattening force to the apparatus. The method also includes the steps of writing written matter on the print-receptive surface and removing the first flattening force. After removing the first flattening force, the print-receptive surface returns to a standing configuration.

In more detailed features of the invention, the method includes the step of scoring applying a second flattening force to the apparatus after removing the first flattening force. The method also includes the steps of editing the written matter on the print-receptive surface and removing the second flattening force. After removing the second flattening force, the print-receptive surface returns to the standing configuration. In additional, more detailed features of the invention, a writing implement is used to write the written matter. In other, more detailed features of the invention, the writing implement can be, for example, a dry-erase marker, a wet-erase marker, a semi-permanent marker, a permanent marker, chalk, a pencil, a pen, or a crayon.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. It should be noted that the drawings are not necessarily drawn to scale. In the drawings wherein like reference numerals represent like parts:

FIG. 1 is a perspective view of a first embodiment of a tent card constructed according to the present invention, the tent card being shown in a free-standing state.

FIG. 2 is an enlarged fragmentary side elevational view of the tent card of FIG. 1.

FIG. 3 is a flowchart, schematically depicting one method that can be used according to the present invention to manufacture the tent card of FIG. 1.

FIGS. 4(a) through 4(e) are top plan views and FIGS. 4(f) through 4(j) are fragmentary sectional views illustrating the tent card at various steps of the method of manufacture of the flowchart of FIG. 3.

FIG. 5 is a flowchart, schematically depicting one method to use the tent card of FIG. 1.

FIG. 6 is a fragmentary side elevational view of the tent card of FIG. 1, showing the tent card being written upon while in a flattened state.

FIG. 7 is a fragmentary side elevational view of a second embodiment of a tent card constructed according to the present invention, the tent card being shown in a free-standing state.

FIG. 8 is a fragmentary side elevational view of a third embodiment of a tent card constructed according to the present invention, the tent card being shown in a free-standing state.

FIG. 9 is a perspective view of a fourth embodiment of a tent card constructed according to the present invention, the tent card being shown in a free-standing state.

FIG. 10 is a fragmentary side elevational view of the tent card of FIG. 9.

FIG. 11 is a flowchart, schematically depicting one method that can be used according to the present invention to manufacture the tent card of FIG. 9.

FIGS. 12(a) through 12(c) are top plan views illustrating the tent card at various steps of the method of manufacture of the flowchart of FIG. 11.

FIG. 13 is a top plan view of a first alternate embodiment to the sheet assembly shown in FIG. 12(c).

FIG. 14 is a top plan view of a second alternate embodiment to the sheet assembly shown in FIG. 12(c).

FIG. 15 is a top plan view of a third alternate embodiment to the sheet assembly shown in FIG. 12(c).

FIG. 16 is a top plan view of a fourth alternate embodiment to the sheet assembly shown in FIG. 12(c).

FIG. 17 is a flowchart, schematically depicting one method to use the tent card of FIG. 9.

FIG. 18 is a fragmentary side elevational view of the tent card of FIG. 9, the tent card being shown in a flattened state suitable, for example, for writing and/or erasing.

FIGS. 19(a) and 19(b) are fragmentary side elevational views of a fifth and sixth embodiment of a tent card constructed according to the present invention, the tent card being shown in a free-standing state.

FIG. 20 is a fragmentary side elevational view of a seventh embodiment of a tent card constructed according to the present invention, the tent card being shown in a free-standing state.

FIG. 21 is a fragmentary side elevational view of a eighth embodiment of a tent card constructed according to the present invention, the tent card being shown in a free-standing state.

FIG. 22 is a perspective view of an ninth embodiment of a tent card constructed according to the present invention, the tent card being shown in a free-standing state.

FIG. 23 is a fragmentary side elevational view of the tent card of FIG. 22.

FIG. 24 is a flowchart, schematically depicting one method that can be used according to the present invention to manufacture the tent card of FIG. 22.

FIGS. 25(a) through 25(c) are top plan views and a side elevational view illustrating the tent card at various steps of the method of manufacture of the flowchart of FIG. 24.

FIG. 26 is a flowchart, schematically depicting one method to use the tent card of FIG. 22.

FIG. 27 is a fragmentary side elevational view of the tent card of FIG. 22, the tent card being shown in a flattened state suitable, for example, for writing and/or erasing.

FIG. 28 is a fragmentary side elevational view of a tenth embodiment of a tent card constructed according to the present invention, the tent card being shown in a free-standing state.

FIG. 29 is a fragmentary side elevational view of a eleventh embodiment of a tent card constructed according to the present invention, the tent card being shown in a free-standing state.

FIG. 30 is a perspective view of an twelfth embodiment of a tent card constructed according to the present invention, the tent card being shown in a free-standing state.

FIG. 31 is a perspective view of a thirteenth embodiment of a tent card constructed according to the present invention, the tent card being shown in a free-standing state.

FIG. 32 is a fragmentary side elevational view of a scoring mechanism.

FIG. 33 is a perspective view of a prior art tent card.

FIG. 34 is a perspective view of another prior art tent card.

### DETAILED DESCRIPTION

The present invention is embodied in a tent card, and related methods, that can be flattened by pressing downwardly and returns to a free-standing state upon removal of the downward force. Tent cards that embody the present invention come in a multitude of configurations. A few non-limiting examples of tent cards are discussed below.

As noted above, the present invention is directed at an apparatus, for example, a tent card, that, after being positioned in a free-standing state, can be flattened by pressing downwardly on the top of the tent card and that returns to a free-standing state on its own as soon as the downwardly applied force is removed. Without wishing to be limited to any particular theory as to how the present invention operates, the tent card of the present invention is resiliently biased towards a free-standing state because, for example, the sides of the tent card are interconnected by a central portion that is doubled-over and joined to itself in some fashion. The description below illustrates some of the different ways in which this doubling-over and joining can be achieved, it being understood that additional ways can be possible and that such additional ways come within the scope of the invention.

Referring now to FIGS. 1 and 2, there are shown perspective and enlarged fragmentary side elevational views, respectively, of a first embodiment of a tent card constructed according to the present invention, the tent card being represented generally by reference numeral 11, and having a height “h”, for example, 1½ inches, 2 inches, or 3 inches. FIG. 1 shows the tent card 11 in the free-standing state on a supporting surface 36. For ease of illustration, certain features of tent card 11 are not shown in FIG. 1 but are shown in FIG. 2.

Tent card 11 can include a first side panel 13, a second side panel 15, and a top 17. First side panel 13, which can be generally planar and rectangular in shape, can include an inwardly facing surface 19, an outwardly facing surface 21, a free edge 23, and a joined edge 25. First side panel 13 can be made from a single layer of print-receptive material, and thus, has a print-receptive surface 22, that is both sufficiently rigid to be self-supporting and sufficiently flexible to permit its flexure about joined edge 25. An example of such a material can be, but is not limited to, a thick paper, for example, 70-pound cover stock or cardstock. Other materials suitable for use as a print-receptive material include, for example, paper, cardboard, films, polymeric sheets, polymer-coated papers, and laminates thereof. Additionally, print-receptive coatings can be added to provide a variety of print-receptive materials. The thickness of the print-receptive material can range from approximately 5 mils to approximately 20 mils, or from approximately 8 mils to approximately 15 mils. Alternatively, as in the case of the present embodiment, first side panel 13 can be a multi-layer construction including a layer 27 of a material having the rigidity and flexibility described above and a dry-erase layer 29 applied to the outwardly facing surface of layer 27 to form a print-receptive surface 22. As shown in FIG. 2, dry-erase layer 29 can also wrap around free edge 23 onto inwardly facing surface 19. Dry-erase layer 29 can be, for example, a conventional dry-erase film, such as a polyethylene terephthalate (PET) film, a polypropylene film (PP), or the like. Alternatively, dry-erase layer 29 can be in the form of a coating on a polymeric film, paper, or laminates thereof. Additionally, in alternative embodiments, suitable dry-erase films can include any material that can be written upon and erased, for example, a layer that can accept markings from writing implements, such as dry-erase markers, wet-erase markers, semi-permanent markers, permanent markers, chalk, pencils, pens, crayons, and other writing implements and have the markings erased after being written.

Second side panel 15, which can have, but need not have, the same dimensions as first side panel 13, can include an inwardly facing surface 31, an outwardly facing surface 33, a free edge 35, and a joined edge 37. Second side panel 15 can be made from a single layer of print-receptive material that is both sufficiently rigid to be self-supporting and sufficiently flexible to permit its flexure about joined edge 37, or, as in the case of the present embodiment, second side panel 15 can be a multi-layer construction including a layer 39 of a material having the rigidity and flexibility described above and a dry-erase layer 41 either in film or coating form applied to the outwardly facing surface of layer 39. As shown in FIG. 2, dry-erase layer 41 can also wrap around free edge 35 onto inwardly facing surface 31. Moreover, as will be discussed further below, in the present embodiment, first side panel 13 and second side panel 15 can be fashioned from the same single layer or multi-layer sheet of material.

Top 17, which can be a generally rectangular planar structure that is joined to first side panel 13 at joined edge 25, and that is joined to second side panel 15 at joined edge 37, can be used to resiliently couple together first side panel 13 and second side panel 15 so that first side panel 13 and second side panel 15 are biased towards an angular orientation in which tent card 11 is in a free-standing state. Top 17, which can include a first flange 45 extending laterally outwardly from first side panel 13 and a second flange 47 extending laterally outwardly from second side panel 15, can be formed from a sheet of material that is doubled-over and adhered to itself. This sheet of material can include the same types of materials that can be used to form side panels 13 and 15. In the present embodiment, top 17 preferably includes the above-described multi-layer construction of a layer 49 having sufficient rigidity to maintain its shape and sufficient flexibility for flexure about joined edges 25 and 37 and a dry-erase layer 51 either in film or coating form applied to the outwardly facing surface of layer 49. Adherence of this doubled-over sheet to itself can be attained using a bonding mechanism such as an adhesive material 53, which can be, but is not limited to, an adhesive coating, for example, a hot-melt adhesive, a pressure-sensitive adhesive, or a glue.

Illustrative examples of suitable adhesive materials 53 include permanent adhesives found in U.S. Pat. No. 5,164,444 to Bernard; U.S. Pat. No. 5,183,459 to Bernard; U.S. Pat. No. 5,189,126 to Bernard; and U.S. Pat. No. 5,264,532 to Bernard; which are incorporated by reference herein in their entireties; and repositionable adhesives disclosed in U.S. Pat. No. 4,810,763 to Mallya, et al.; U.S. Pat. No. 4,944,888 to Mallya, et al.; and U.S. Pat. No. 5,656,705 to Mallya, et al.; all of which are incorporated by reference herein in their entireties. Other examples of suitable adhesives include E5500 (Avery Dennison Corporation of Pasadena, Calif.), E5570 (Avery Dennison Corporation of Pasadena, Calif.), E5600 (Avery Dennison Corporation of Pasadena, Calif.), PRIMAL EP-5560F (Dow Chemical Company of Midland, Mich.), UR2 (Avery Dennison Corporation of Pasadena, Calif.), MICRONAX 240-00 (Franklin International of Columbus, Ohio), GEL-TAC (Paper Conversions, Inc. (PCI) of Syracuse, N.Y.), COVINAX 210-00 (Franklin International of Columbus, Ohio), and R-423 (Avery Dennison Corporation of Pasadena, Calif.). Alternatively, adhesive material 53 can be in the form of a double-sided adhesive tape or transfer tape, for example, SCOTCH 667 REMOVABLE DOUBLE SIDED TAPE (3M, Corp. of St. Paul, Minn.), SCOTCH 665 PERMANENT DOUBLE SIDED TAPE (3M, Corp. of St. Paul, Minn.), FT 445 (Avery Dennison Corp. of Pasadena, Calif.), OCB 2041 (Avery Dennison Corp. of Pasadena, Calif.), OCB 2042 (Avery Dennison Corp. of Pasadena, Calif.), OCB 2043 (Avery Dennison Corp. of Pasadena, Calif.), or OCB 2044 (Avery Dennison Corp. of Pasadena, Calif.). As in the embodiment shown, it is not necessary to apply adhesive material 53 in the space 54 between side panels 13 and 15 in order to avoid promoting the collection of dust and other debris. Notwithstanding the above, the present invention does not preclude the application of adhesive material 53 in space 54.

As will be discussed further below, in the present embodiment, top 17 can be fashioned from the same single layer or multi-layer sheet of material used to fashion side panels 13 and 15.

It should be noted that, although, in the present embodiment, top 17 is shown parallel to the supporting surface 36 that the tent card 11 stands on (see FIGS. 1 and 2), top 17 can be angled towards either first side panel 13 or second side panel 15. In fact, it can be advantageous, for purposes of shipping and/or storage, for top 17 to be angled so that it is substantially flat against either first side panel 13 or second side panel 15.

Tent card 11 can additionally include a biasing mechanism, for example, a first piece of low-stretch film 61 coupled to the inside surfaces of first side panel 13 and first flange 45 across joined edge 25, and can further include a second piece of low-stretch film 63 coupled to the inside surfaces of second side panel 15 and second flange 47 across joined edge 37. Films 61 and 63 can include, but are not limited to, conventional strips of adhesive tape, for example, SCOTCH MAGIC 810 TAPE (3M, Corp. of St. Paul, Minn.). Films 61 and 63 can also be made from materials such as, for example, PET and other polyesters, polypropylene (PP), polyethylene (PE), and other polyolefins, nylon and other polyamides, reinforced paper, for example, polypropylene coated paper, and non-woven fabrics such as, for example, TYVEK (E.I. du Pont de Nemours and Company, of Wilmington, Del.). Thickness of films 61 and 63 can range from approximately 0.5 mil to approximately 8.0 mils, or from approximately 1.0 mil to approximately 4.0 mils, or from approximately 1.0 mil to approximately 2.0 mils. Films 61 and 63 tend to bias panels 13 and 15 to their free-standing orientation relative to the supporting surface 36 and, as a result, add additional recoil force from a flattened state. Bias toward the free-standing orientation can be enhanced, for example, by applying films 61 and 63 to a flat sheet 71, as shown in FIG. 4(c), and discussed below. Because the films 61 and 63 tend to resist stretching, upon folding the flat sheet 71, the films 61 and 63 resist stretching around the joined edges 25 and 37, respectively, resulting in a bias toward the free-standing state, in which the flat sheet 71 is folded to a lesser degree. (see, for example, joined edge 25 in FIGS. 2 and 6)

Referring now to FIG. 3, there is shown a flowchart, schematically depicting one method that can be used to manufacture tent card 11 in accordance with the present invention, the method being represented generally by reference numeral 70. In addition, the intermediate sheets resulting from some of the steps of method 70 are depicted in FIGS. 4(a) through 4(d). Method 70 can begin in a step 70-1 with the provision of a flat sheet 71 (see also FIG. 4(a)). Flat sheet 71 can include, for example, a 7 inches by 8½ inches sheet of 70-pound cover stock or cardstock 73 (see also cardstock 173 in FIG. 12(a) and cardstock 273 in FIG. 25(a)) with a dry-erase film 75 (see also dry-erase layers 29, 41, 51 in FIG. 2, dry-erase film 175 in FIG. 12(a), and dry-erase film 275 in FIG. 25(a)) coupled to one side. It should be appreciated, that the flat sheet 71 can be a roll of sheet material instead of a single sheet of material. If desired, dry-erase film 75 can wrap around to the opposite side of cardstock 73 to protect from fraying what will later become the free edges 23 and 35 of tent card 11.

Method 70 can include a step 70-2 wherein a series of longitudinal score lines are formed on sheet 71 to yield a sheet 72 (see also FIG. 4(b)). As used herein, the term “score lines” includes score lines, perforated lines, lines of cuts and ties, and other lines that facilitate folding the sheet. The score lines can be formed on sheet 71 using conventional scoring techniques, for example, by pressing the sheet 71 between two metal surfaces 97 and 98, one of which has a recessed groove 99 and the other a tongue 100 (see FIG. 32), and can include an inner pair of score lines 77-1 and 77-2 and an outer pair of score lines 79-1 and 79-2. Alternatively, the score lines can be formed in a similar fashion, except that one of the metal surfaces 98 can be flat instead of having a recessed groove 99. Inner score lines 77-1 and 77-2 can be spaced from the longitudinal centerline 78 and can be spaced apart from each other by a distance d₃ of, for example, approximately ½ inch. Alternatively, inner score lines 77-1 and 77-2 can be spaced apart from each other by a distance d₃ that ranges from, for example, approximately ¼ inch to 2 inches. Outer score lines 79-1 and 79-2 can be spaced from inner score lines 77-1 and 77-2, respectively, with the sum of the distance d₁ between score lines 77-1 and 79-1 and the distance d₂ between score lines 77-2 and 79-2 being equal to or slightly less than the distance d₃ between inner score lines 77-1 and 77-2. Therefore, for example, where inner score lines 77-1 and 77-2 are spaced apart by approximately ½ inch, the spacing between score lines 77-1 and 79-1 and between score lines 77-2 and 79-2 can be approximately ¼ inch. Accordingly, as shown in FIG. 4(b), the distances d₁ and d₂ are approximately equal; however, it should be appreciated that the distances d₁ and d₂ can be unequal. Also, as will become apparent, the portion of sheet 72 lying between outer score lines 79-1 and 79-2 will later become top 17, and the portions of sheet 72 lying outside outer score lines 79-1 and 79-2 will later become first and second side panels 13 and 15, respectively. Score lines 77-1, 77-2, 79-1, and 79-2 can be on the same surface 65 of sheet 72; alternatively, score lines 77-1 and 77-2 can be on the opposite surface 67 of the sheet 72 as score lines 79-1 and 79-2; or alternatively, one or more of score lines 77-1, 77-2, 79-1, and 79-2 can be on the opposite surface 67 of the sheet 72 as the other score lines.

Method 70 can also include a step 70-3 wherein two strips of low-stretch film 61 and 63 are coupled to sheet 72 to yield sheet assembly 74 (see also FIGS. 4(c) and 4(f)), first strip 61 being applied to and covering score line 79-1 and second strip 63 being applied to and covering score line 79-2. Strips 61 and 63 can be conventional one-sided adhesive tape, for example, clearing packing tape. Method 70 can further include a step 70-4 wherein two strips of adhesive material 53 are applied to sheet assembly 74 to yield sheet assembly 76 (see also FIGS. 4(d) and 4(i)), one strip of adhesive material 53 being applied between score line 77-1 and the centerline 78 of sheet 72 and the other strip of adhesive material 53 being applied between score line 77-2 and the centerline 78 of sheet 72. Alternatively, a single strip of adhesive material 55 can be applied between the score lines 77-1 and 77-2, as shown in FIGS. 4(e) and 4(j). Additionally, method 70 can include a step 70-5 wherein sheet assembly 76 is folded inwardly onto itself about score lines 77-1 and 77-2 to define top 17 and with the outward bending of the portions of sheet assembly 76 outside of score lines 79-1 and 79-2 to define side panels 13 and 15, respectively.

Referring now to FIG. 5, there is shown a flowchart, schematically depicting one method of using the tent card 11 in accordance with the present invention, said method being represented generally by reference numeral 80. As can be seen, method 80 can begin in a step 80-1 with the flattening of tent card 11 against a horizontal supporting surface 36 (see also FIG. 6), such flattening being done, for example, by a user 90 pressing downwardly on top 17 of tent card 11 with a flattening force 92. Then, with tent card 11 in such a flattened state, method 80 can continue in a step 80-2 with the user 90 writing written matter 94 on the print-receptive surface 22 of panels 13 and/or 15 using a suitable writing implement 96 (see also FIG. 6). Then, once the writing is complete, method 80 can continue in a step 80-3 with the removal of the flattening force 92 from tent card 11, for example, by the cessation of pressing downwardly on top 17 of tent card 11, thereby allowing tent card 11 to return to a free-standing state with the print-receptive surface 22 in a standing configuration, such as is shown in FIG. 1. Then, method 80 can continue in a step 80-4 with the user 90 deciding whether or not to edit any of the written matter 94 on tent card 11. If no editing is desired, method 80 can conclude, as represented by 80-5. If editing is desired, method 80 can continue in a step 80-6 with the flattening of the tent card 11, which can be done in a manner similar to that described above in step 80-1. Then, method 80 can continue in a step 80-7 with the editing of the written matter 94 on tent card 11, for example, by erasing and/or writing. Then, once editing is complete, method 80 can continue in a step 80-8 with the removal of the flattening force from tent card 11, which can be done in a manner similar to that in step 80-3. Then, after step 80-8, method 80 returns to step 80-4.

Referring now to FIG. 7, there is shown a fragmentary side elevational view of a second embodiment of a tent card constructed according to the present invention, the tent card being represented generally by reference numeral 81. Tent card 81 can be similar in most respects to tent card 11, the principal difference between the two tent cards being that, whereas tent card 11 includes a low-stretch film 61 coupled to the inside surfaces of first side panel 13 and first flange 45 across joined edge 25 and includes a low-stretch film 63 coupled to the inside surfaces of second side panel 15 and second flange 47 across joined edge 37, tent card 81 includes, instead of films 61 and 63, a low-stretch film 83 coupled to the outside surfaces of first side panel 13 and first flange 45 across joined edge 25 and a low-stretch film 85 coupled to the outside surfaces of second side panel 15 and second flange 47 across joined edge 37. Low-stretch films 83 and 85 can be made from the same materials as low-stretch films 61 and 63. The sheet assembly 82 shown in FIG. 4(g) can be used to form tent card 81.

Referring now to FIG. 8, there is shown a fragmentary side elevational view of a third embodiment of a tent card constructed according to the present invention, the tent card being represented generally by reference numeral 91. Tent card 91 can be similar in most respects to tent card 11, the principal difference between the two tent cards being that, whereas tent card 11 includes a low-stretch film 61 coupled to the inside surfaces of first side panel 13 and first flange 45 across joined edge 25 and includes a low-stretch film 63 coupled to the inside surfaces of second side panel 15 and second flange 47 across joined edge 37, tent card 91 additionally includes a low-stretch film 93 coupled to the outside surfaces of first side panel 13 and first flange 45 across joined edge 25 and a low-stretch film 95 coupled to the outside surfaces of second side panel 15 and second flange 47 across joined edge 37. Low-stretch films 93 and 95 can be made from the same materials as low-stretch films 61 and 63. The sheet assembly 84 shown in FIG. 4(h) can be used to form tent card 91.

Referring now to FIGS. 9 and 10, there are shown perspective and fragmentary side elevational views, respectively, of a fourth embodiment of a tent card constructed according to the present invention, the tent card being represented generally by reference numeral 111. For ease of illustration, certain features of tent card 111 are not shown in FIG. 9 but are shown in FIG. 10.

Tent card 111 can include a first side panel 113 and a second side panel 115. First side panel 113, which can be generally planar and rectangular in shape, can include an inwardly facing surface 119, an outwardly facing surface 121, a free edge 123, and a panel portion 125. First side panel 113 can be made from a single layer of print-receptive material, and thus, has a print-receptive surface 122, that is both sufficiently rigid to be self-supporting and sufficiently flexible to permit some flexure proximate to panel portion 125. An example of such a material can be, but is not limited to, for example, a thick paper, such as 70-pound cover stock or cardstock. Alternatively, as in the case of the present embodiment, first side panel 113 can be a multi-layer construction including a layer 127 of a material having the rigidity and flexibility described above and a dry-erase layer 129 applied to the outwardly facing surface of layer 127. As shown in FIG. 10, dry-erase layer 129 can also wrap around free edge 123 onto inwardly facing surface 119. Dry-erase layer 129 can be made of the same materials as dry-erase layer 29.

Second side panel 115, which can have, but need not have, the same dimensions as first side panel 113, can include an inwardly facing surface 131, an outwardly facing surface 133, a free edge 135, and a panel portion 137. Second side panel 115 can be made from a single layer of print-receptive material that is both sufficiently rigid to be self-supporting and sufficiently flexible to permit its flexure proximate to panel portion 137, or, as in the case of the present embodiment, second side panel 115 can be a multi-layer construction including a layer 139 of a material having the rigidity and flexibility described above and a dry-erase layer 141 either in film or coating form applied to the outwardly facing surface of layer 139. As shown in FIG. 10, dry-erase layer 141 can also wrap around free edge 135 onto inwardly facing surface 131. Moreover, as will be discussed further below, in the present embodiment, first side panel 113 and second side panel 115 can be fashioned from the same single layer or multi-layer sheet of material, with panel portions 125 and 137 being joined to one another at the score line 177. (see FIG. 12)

Second side panel 115 can additionally include a longitudinal score line 143 extending parallel to and spaced a short distance from panel portion 137. In one embodiment, the longitudinal score line 143 is on the outwardly facing surface 133 of the second side panel 115.

A top 154 of tent card 111 can be formed at the panel portions 125 and 137 using an adhesive material 153 to couple the side panels 113 and 115 to one another. Adhesive material 153 can be similar to adhesive material 53. Alternatively, adhesive material 153 can be the same material as adhesive material 53.

Referring additionally to FIG. 11, there is shown a flowchart, schematically depicting one method that can be used to manufacture tent card 111 in accordance with the present invention, said method being represented generally by reference numeral 170. In addition, the intermediate sheets resulting from some of the steps of method 170 are also depicted in FIGS. 12(a) through 12(c). Method 170 can begin in a step 170-1 with the provision of a flat sheet 171 (see also FIG. 12(a)). Flat sheet 171 can include, for example, a 7 inches by 8½ inches sheet of 70-pound cover stock or cardstock 173 with a dry-erase film 175 coupled to one side. If desired, film 175 can wrap around to the opposite side of cardstock 173 to protect from fraying what will later become the free edges 123 and 135 of tent card 111. Method 170 can include a step 170-2, wherein the two lines 177 and 179 on sheet 171 are scored, using conventional scoring techniques, for example, by pressing the sheet between two metal surfaces 97 and 98, one of which has a recessed groove 99 and the other a tongue 100 (see FIG. 32), to produce a sheet 174 (see also FIG. 12(b)). The score lines of sheet 174 include a score line 177 provided along the longitudinal centerline of sheet 174 and a score line 179 parallel to and spaced a short distance, for example, ½ inch, from score line 177. Alternatively, score lines 177 and 179 can be spaced apart by, for example, from approximately ¼ inch to approximately 1½ inch, or from approximately ¾inch to approximately 1 inch. The score lines 177 and 179 can be on the same side of sheet 174 or can be on opposite sides of the sheet. As will become apparent below, score line 177, which is folded, defines the boundary between the first panel 113 and the second panel 115 and score line 179 will become score line 143 on second side panel 115. If desired, an additional longitudinal score line can be provided on the opposite side of score line 177, for example, score line 279-1 as seen in FIG. 25(b) as discussed below. Also, method 170 can include a step 170-3 wherein a strip of adhesive material 153, which can be, for example, a double-sided pressure sensitive tape, is applied to sheet 174 to yield a sheet assembly 176 (see also FIG. 12(c)). The strip of adhesive material 153 is applied longitudinally over sheet 174, with strip of adhesive material 153 being centered over score line 177, shown in phantom in FIG. 12(c), and extending just short of score line 179. Additionally, method 170 can include in a step 170-4 wherein sheet assembly 176 is folded inwardly onto itself about score line 177 to form top 154 that includes a double thickness of adhesive strip 153 that is coupled to itself and to inner surfaces 119 and 131.

FIGS. 13 through 16 show alternate embodiments to sheet assembly 176. FIG. 13 shows a sheet assembly 180 that differs from sheet assembly 176 in that, whereas sheet assembly 176 includes a strip of adhesive material 153, sheet assembly 180 includes a strip of double-sided pressure-sensitive adhesive material 181 that is as wide as, or less than, the spacing between score line 177 and score line 179 and that is placed between score line 177 and score line 179. Double-sided pressure-sensitive adhesive material 181 can be the same material used for adhesive material 53. FIG. 14 shows a sheet assembly 182 that differs from sheet assembly 180 in that a strip of double-sided pressure-sensitive adhesive material 184 is placed on the other side of score line 177. When sheet assembly 180 or sheet assembly 182 is folded inwardly onto itself about score line 177, the top 154 includes a single thickness of adhesive strip 181 or 184, respectively. FIG. 15 shows a sheet assembly 185 that differs from sheet assembly 176 in that, whereas sheet assembly 176 includes adhesive material 153 that extends all the way from one edge 171-1 to the opposite edge 171-2, sheet assembly 185 includes a strip 186 of adhesive material that stops short of edges 171-1 and 171-2. Thus, the strip has a length “l_{ST}” that is less than the length “l_{SH}” of the sheet, and accordingly, less that the length “l” of the tent card 111. (see also FIG. 30) FIG. 16 shows a sheet assembly 187 that differs from sheet assembly 176 in that sheet assembly 187 includes a plurality of strips 188 of adhesive. As used herein, the term “plurality” means two or more.

Referring now to FIG. 17, there is shown a flowchart, schematically depicting one method of using the tent card 111 in accordance with the present invention, said method being represented generally by reference numeral 190. As can be seen, method 190 can begin in a step 190-1 with the flattening of tent card 111 against a horizontal supporting surface 136 (see also FIG. 18), such flattening being done, for example, by a user 90 pressing downwardly on top 154 of tent card 111 with a flattening force 92. Then, with tent card 111 in such a flattened state, method 190 can continue in a step 190-2 with the user 90 writing written matter 94 on panels 113 and/or 115 using a suitable writing implement 96 (see, for example, FIG. 6). Then, once writing is complete, method 190 can continue in a step 190-3 with the removal of the flattening force 92 from tent card 111, for example, by the cessation of pressing downwardly on top 154 of tent card 111, thereby allowing tent card 111 to return to a free-standing state, such as is shown in FIG. 9. Then, method 190 can continue in a step 190-4 with the user 90 deciding whether or not to edit any of the written matter 94 on tent card 111. If no editing is desired, method 190 can conclude, as represented by 190-5. If editing is desired, method 190 can continue in a step 190-6 with the flattening of the tent card 111, which can be done in a manner similar to that described above in step 190-1. Then, method 190 can continue in a step 190-7 with the editing of the written matter 94 on tent card 111, for example, by erasing and/or writing. Then, once editing is complete, method 190 can continue in a step 190-8 with the removal of the flattening force from tent card 111, which can be done in a manner similar to that in step 190-3. Then, after step 190-8, method 190 returns to step 190-4.

Referring now to FIG. 19(a), there is shown an enlarged fragmentary side elevational view of a fifth embodiment of a tent card constructed according to the present invention, the tent card being represented generally by reference numeral 195. Tent card 195 can be similar in most respects to the tent card 111, the principal difference between the two tent cards being that tent card 195 can additionally include a strip 197 of low-stretch film coupled at the score line 143 on the inwardly facing surface 131. Low-stretch film 197 can be made from the same materials as low-stretch films 61 and 63. Strip 197 biases side panel 115 to a straightened or non-flexed state relative to the top 154. A sixth embodiment 196 is shown in FIG. 19(b), in which strip 197 is coupled at the score line 143 on the outwardly facing surface 133.

Referring now to FIG. 20, there is shown an enlarged fragmentary side elevational view of a seventh embodiment of a tent card constructed according to the present invention, the tent card being represented generally by reference numeral 199. Tent card 199 can be similar in most respects to the tent card 195, the principal difference between the two tent cards being that tent card 199 can additionally include a strip 201 of low-stretch film coupled to the inwardly facing surface 119 at a location near the score line 143 to reinforce and reduce unwanted creasing of the first side panel 113 that can occur during repeated application of a downward force. Low-stretch film 201 can be made from the same materials as low-stretch films 61 and 63. Strip 201 can also enhance the first side panel to return to a free-standing state if unwanted creasing occurs.

Referring now to FIG. 21, there is shown an enlarged fragmentary side elevational view of a eighth embodiment of a tent card constructed according to the present invention, the tent card being represented generally by reference numeral 203. Tent card 203 can be similar in most respects to the tent card 111, the principal difference between the two tent cards being that the first side panel 113 of tent card 203 can include a score line 205 on the outwardly facing surface 121 that corresponds to score line 143 in the second side panel 115 such that the top 154 is oriented perpendicularly to the supporting surface 136 that the tent card 203 is placed upon.

Referring now to FIGS. 22 and 23, there are shown perspective and fragmentary side elevational views, respectively, of an ninth embodiment of a tent card constructed according to the present invention, the tent card being represented generally by reference numeral 211.

Tent card 211 can include a first side panel 213 and a second side panel 215. First side panel 213, which can be generally planar and rectangular in shape, can include an inwardly facing surface 219, an outwardly facing surface 221, a free edge 223, a panel portion 225, and a score line 226. Side panel 213 can be made from a single layer of print-receptive material that is both sufficiently rigid to be self-supporting and sufficiently flexible to permit some flexure about score line 226. An example of such a material can be, but is not limited to, a thick paper, such as 70-pound cover stock or cardstock, or plastic sheets, for example 5 mils to 10 mils thick polypropylene or polyethylene. Alternatively, as in the case of the present embodiment, side panel 213 can be a multi-layer construction including a layer 227 of a material having the rigidity and flexibility described above and a dry-erase layer 229 applied to the outwardly facing surface of layer 227. As shown in FIG. 23, dry-erase layer 229 can also wrap around free edge 223 onto inwardly facing surface 219. Dry-erase layer 229 can be made of the same materials as dry-erase layer 29.

Second side panel 215, which can have, but need not have, similar dimensions to first side panel 213, can include an inwardly facing surface 231, an outwardly facing surface 233, a free edge 235, a panel portion 237, and a score line 238. Side panel 215 can be made from a single layer of print-receptive material that is both sufficiently rigid to be self-supporting and sufficiently flexible to permit its flexure about score line 238, or, as in the case of the present embodiment, side panel 215 can be a multi-layer construction including a layer 239 of a material having the rigidity and flexibility described above and a dry-erase layer 241 either in film or coating form applied to the outwardly facing surface of layer 239. As shown in FIG. 23, dry-erase layer 241 can also wrap around free edge 235 onto inwardly facing surface 231. Moreover, as will be discussed further below, in the present embodiment, panel 213 and panel 215 can be fashioned from the same single layer or multi-layer sheet of material, with panel portions 225 and 237 being joined to one another at the centerline of the sheet.

Card 211 can further include an elongated mechanical fastener or clip 250, which can be, for example, a conventional plastic or metal report cover clip. Clip 250 can be appropriately constructed to join together panel portion 225 and panel portion 237. As shown in FIG. 23, clip 250 wraps around panel portions 225 and 237, and extends to score lines 226 and 238, thereby inhibiting panel portions 225 and 237 from separating. Alternatively, clip 250 need not extend to score lines 226 and 238, but can stop short of score lines 226 and 238, thereby inhibiting panel portions 225 and 237 from separating. It should be appreciated that panel portions 225 and 237 can be coupled with adhesive material 153 in addition to clip 250 joining them together.

Referring now to FIG. 24, there is shown a flowchart, schematically depicting one method that can be used to manufacture tent card 211 in accordance with the present invention, said method being represented generally by reference numeral 270. In addition, the intermediate sheets resulting from some of the steps of method 270 are also depicted in FIGS. 25(a) through 25(c). Method 270 can begin in a step 270-1 with the provision of a flat sheet 271 (see also FIG. 25(a)). Flat sheet 271 can include, for example, a 7 inches by 8½ inches sheet of 70-pound cover stock or cardstock 273 with a dry-erase film 275 coupled to one side. If desired, film 275 can wrap around to the opposite side of cardstock 273 to protect from fraying what will later become the free edges 223 and 235 of the tent card 211. Method 270 can include a step 270-2 wherein three lines are scored on sheet 271, using conventional scoring techniques, for example, by pressing the sheet between two 97 and 98 surfaces, one of which has a recessed groove 99 and the other a tongue 100 (see FIG. 32), to produce a sheet 272 (see also FIG. 25(b)). The score lines include a score line 277 provided along the longitudinal centerline of sheet 271 and a pair of score lines 279-1 and 279-2 parallel to and spaced a short distance, e.g., approximately ½ inch, from score line 277. The score lines 279-1 and 279-2 are on the same surface of sheet 272 as score line 277. Alternatively, score lines 279-1 and 279-2 can be spaced from score line 277 by, for example, from approximately ¼ inch to approximately 1½ inches, or from approximately ¾inch to approximately 1 inch. As shown in FIG. 25(b), score lines 279-1 and 279-2 are equally spaced from score line 277; however, score lines 279-1 and 279-2 can be unequally spaced from score line 277. Alternatively, score lines 279-1 and 279-2 can be on the opposite surface of sheet 272 as score line 277. As will become apparent below, score line 279-1 will become score line 226 on panel 213 and score line-279-2 will become score line 238 on panel 215. Next, method 270 can continue in a step 270-3 with the folding of sheet 272 onto itself about score line 277 and bent away from itself at score lines 279-1 and 279-2 to produce sheet 274 (see also FIG. 25(c)). Next, method 270 can conclude in a step 270-4 with the placing of clip 250 (see also FIG. 22) over the top 280 of sheet 274 to join together the folded-over areas 282 of the sheet between score lines 279-1 and 279-2.

Referring now to FIG. 26, there is shown a flowchart, schematically depicting one method of using the tent card 211 in accordance with the present invention, said method being represented generally by reference numeral 290. As can be seen, method 290 can begin in a step 290-1 with the flattening of tent card 211 against a horizontal supporting surface 236 (see also FIG. 27), such flattening being done, for example, by a user 90 pressing downwardly on clip 250 with a flattening force 92. Then, with tent card 211 in such a flattened state, method 290 can continue in a step 290-2 with the user 90 writing written matter 94 on panels 213 and/or 215 using a suitable writing implement 96 (see, for example, FIG. 6(b)). Then, once writing is complete, method 290 can continue in a step 290-3 with the removal of the flattening force 92 from tent card 211, for example, by the cessation of pressing downwardly on clip 250, thereby allowing tent card 211 to return to a free-standing state, such as is shown in FIG. 23. Then, method 290 can continue in a step 290-4 with the user 90 deciding whether or not to edit any of the written matter 94 on tent card 211. If no editing is desired, method 290 can conclude, as represented by 290-5. If editing is desired, method 290 can continue in a step 290-6 with the flattening of the tent card 211, which can be done in a manner similar to that described above in step 290-1. Then, method 290 can continue in a step 290-7 with the editing of the written matter 94 on tent card 211, for example, by erasing and/or writing. Then, once editing is complete, method 290 can continue in a step 290-8 with the removal of the flattening force from tent card 211, which can be done in a manner similar to that in step 290-3. Then, after step 290-8, method 290 returns to step 290-4.

Referring now to FIG. 28, there is shown a fragmentary side elevational view of a tenth embodiment of a tent card constructed according to the present invention, the tent card being represented generally by reference numeral 311. Tent card 311 can be similar in most respects to tent card 211, the principal difference between the two tent cards being that score line 238 is omitted in tent card 311.

Referring now to FIG. 29, there is shown a fragmentary side elevational view of a eleventh embodiment of a tent card constructed according to the present invention, the tent card being represented generally by reference numeral 351. Tent card 351 can be similar in most respects to tent card 211, the principal difference between the two tent cards being that card 351 can additionally include a strip 353 of low-stretch film coupled on inwardly facing surface 219 and on inwardly facing surface 231 at the juncture 355 of first side panel 213 and second side panel 215, with one end of strip 353 secured to inwardly facing surface 219 and with the opposite end of strip 353 secured to inwardly facing surface 231. Low-stretch film 353 can be made from the same materials as low-stretch films 61 and 63.

Referring now to FIG. 30, there is shown a perspective view of an twelfth embodiment of a tent card constructed according to the present invention, the tent card being shown in a free-standing state and being represented generally by reference numeral 411. Tent card 411 can be similar in most respects to tent card 211, the principal difference between the two tent cards being that, whereas tent card 211 can include a clip 250 that is dimensioned to fit over the entire length “l” of center score line 277 (see FIG. 25(b)), card 411 can include a clip 450 that is dimensioned to fit over only a portion of the length “lₚ” of a center score line 477. Like clip 250, clip 450 can be made of plastic or metal. Tent card 411 can be used similarly to tent card 211.

Referring now to FIG. 31, there is shown a perspective view of a thirteenth embodiment of a tent card constructed according to the present invention, the tent card being shown in a free-standing state and being represented generally by reference numeral 511. Tent card 511 can be similar in most respects to tent card 411, the principal difference between the two tent cards being that tent card 511 can be embossed to include a peripheral frame 513 surrounding a central writing area 515 on one or both side panels 213, 215. As shown in FIG. 31, the central writing area 515 can be rectangular, however, in other example embodiments, the central writing area 515 can be a different shape, for example, round, oval, rounded rectangular, or other decorative shapes. In addition to having a decorative effect, the peripheral frame 513 can act as a guide or boundary for the writing area, providing both a tactile and visual border. As can be appreciated, although peripheral frame 513 is shown in the present embodiment as being raised relative to writing area 515, writing area 515 could be raised relative to frame 513. Alternatively, a dry-erase film can be adhered to the central writing area 515, with the peripheral frame 513 being free of dry-erase film. Tent card 511 can be used similarly to tent card 411.

It is to be understood that, in connection with the various embodiments discussed above, the dry-erase film or coating can be omitted, as long as the writing areas have a print-receptive surface, or can be replaced with a wet-erase film or coating, or with a semi-permanent marker erasable film or coating.

Advantageously, the present invention provides a tent card that can be easily written upon and edited multiple times without reassembly or refolding. The tent card returns to a free-standing state after being written upon or edited without user intervention.

All features disclosed in the specification, including the claims, abstract, and drawings, and all steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

We claim:

1. An apparatus that is configured to stand on a supporting surface, the apparatus comprising:
a. a print-receptive surface; and
b. a biasing mechanism that is configured to bias the print-receptive surface into a standing configuration relative to the supporting surface.

2. The apparatus of claim 1, wherein the apparatus is a tent card.

3. The apparatus of claim 1, wherein the print-receptive surface is selected from the group consisting of dry-erase film, wet-erase film, semi-permanent marker erasable film, polypropylene film (PP), polymeric film, paper, laminates thereof, and coatings thereof.

4. The apparatus of claim 1, wherein the print-receptive surface is configured to accept markings from a writing implement selected from the group consisting of dry-erase markers, wet-erase markers, semi-permanent markers, permanent markers, chalk, pencils, pens, and crayons.

5. The apparatus of claim 1, wherein the biasing mechanism includes a strip of film.

6. The apparatus of claim 5, wherein:
a. the strip of film is made of a material; and
b. the material is selected from the group consisting of polyesters (PET), polypropylene (PP), polyethylene (PE), polyolefins, polyamides, reinforced papers, and non-woven fabrics.

7. The apparatus of claim 1, wherein:
a. the apparatus includes a first panel; and
b. the print-receptive surface is part of the first panel.

8. The apparatus of claim 7, wherein the biasing mechanism is coupled to the first panel.

9. The apparatus of claim 7, wherein the apparatus further includes a second panel that is coupled to the first panel.

10. The apparatus of claim 9, wherein:
a. the first panel includes a first panel portion;
b. the second panel includes a second panel portion; and
c. the first panel portion is coupled to the second panel portion.

11. The apparatus of claim 10, wherein:
a. the biasing mechanism includes a first strip of film; and
b. the first strip of film is coupled to the first panel portion.

12. The apparatus of claim 11, wherein:
a. the first panel has a first panel surface; and
b. the first strip of film is coupled to the first panel surface.

13. The apparatus of claim 12, wherein:
a. the second panel has a second panel surface;
b. the biasing mechanism includes a second strip of film; and
c. the second strip of film is coupled to the second panel portion and the second panel surface.

14. The apparatus of claim 11, wherein:
a. the biasing mechanism include a plurality of strips of film; and
b. the plurality of strips of film includes the first strip of film.

15. The apparatus of claim 11, wherein:
a. the apparatus has a length;
b. the first strip of film has a length; and
c. the length of the first strip of film is less than the length of the apparatus.

16. The apparatus of claim 9, wherein:
a. the apparatus further comprises a bonding mechanism; and
b. the bonding mechanism couples the first panel to the second panel.

17. The apparatus of claim 16, wherein the bonding mechanism is selected from the group consisting of an adhesive, a double-sided adhesive tape, a transfer tape, a permanent adhesive, a removable adhesive, a glue, and a pressure-sensitive adhesive.

18. The apparatus of claim 9, further including a fastener that is configured to contact both the first panel and the second panel.

19. The apparatus of claim 18, wherein the fastener is a clip.

20. The apparatus of claim 9, wherein the first panel and the second panel are formed from a single sheet of material.

21. The apparatus of claim 20, wherein the sheet of material is selected from the group consisting of a paper, cardboard, a film, a polymeric sheet, a polymer-coated paper, and laminates thereof.

22. The apparatus of claim 20, wherein:
a. the single sheet of material includes a fold; and
b the fold defines a boundary between the first panel and the second panel.

23. The apparatus of claim 9, wherein at least one of the first panel and the second panel includes an embossed writing area.

24. A method of manufacturing an apparatus that is configured to stand on a supporting surface, the method comprising:
a. providing a flat sheet having a print-receptive surface; and
b. coupling a biasing mechanism to the flat sheet;
c. wherein the biasing mechanism is configured to bias the flat sheet into a standing configuration relative to the support surface.

25. The method of claim 24, further comprising scoring the flat sheet to form a fold line, wherein:
a. the apparatus includes a first panel and a second panel; and
b. the fold line defines a boundary between the first panel and the second panel.

26. The method of claim 25, further comprising applying a bonding mechanism to the flat sheet.

27. The method of claim 26, further comprising:
a. folding the flat sheet along the fold line; and
b. coupling the first panel to the second panel with the bonding mechanism.

28. The method of claim 24, wherein the biasing mechanism is a strip of film.

29. The method of claim 24, further comprising embossing the flat sheet.

30. A method of using an apparatus that includes a print-receptive surface and that is configured to stand on a supporting surface, the method comprising:
a. applying a first flattening force to the apparatus;
b. writing written matter on the print-receptive surface; and
c. removing the first flattening force;
d. wherein after removing the first flattening force, the print-receptive surface returns to a standing configuration.

31. The method of claim 30, further comprising:
a. after removing the first flattening force, applying a second flattening force to the apparatus;
b. editing the written matter on the print-receptive surface; and
c. removing the second flattening force;
d. wherein after removing the second flattening force, the print-receptive surface returns to the standing configuration.

32. The method of claim 30, wherein a writing implement is used to write the written matter.

33. The method of claim 32, wherein the writing implement is selected from the group consisting of dry-erase markers, wet-erase markers, semi-permanent markers, permanent markers, chalk, pencils, pens, and crayons.
